(19) United States
(12) Patent Application Publication
(10) Pub. No.: US 2026/0320789 A1
(43) Pub. Date: Oct. 15, 2026

(54) SYSTEMS AND METHODS FOR RECOGNIZING SCAR TISSUE

(71) Applicant: Biosense Webster (Israel) Ltd., Yokneam (IL)

(72) Inventors: Nadav Barnea, Haifa (IL); Hanna Cohen Sacomsky, Zichron Ya'acov (IL); Elad Azaria, Ramat Gan (IL); Roy Urman, Haifa (IL); Morris Ziv-Ari, Atlit (IL); Guy Haiman, Haifa (IL)

(21) Appl. No.: 19/570,002

(22) Filed: Mar. 17, 2026

Related U.S. Application Data
(60) Provisional application No. 63/788,550, filed on Apr. 14, 2025.

(51) Int. Cl. G06T 7/00; G06T 5/00; G06T 7/11; G06T 7/136; G06T 7/41

(52) U.S. Cl. CPC G06T 7/0012; G06T 5/00; G06T 7/11; G06T 7/136; G06T 7/41; G06T 2207/10136; G06T 2207/20112; G06T 2207/20172; G06T 2207/30096

(57) ABSTRACT

Methods may include receiving data indicative of an image of an anatomical structure. Methods may include determining, based on the image, a classification of tissue of the anatomical structure. The classification may include determining one or more of healthy tissue or scar tissue. Methods may include generating a first classification tag indicative of the determined healthy tissue. Methods may include generating a second classification tag indicative of the determined scar tissue. Methods may include causing the first classification tag and the second classification tag to be displayed.

### CROSS-REFERENCE TO RELATED APPLICATION

This application is a Nonprovisional of and claims the benefit of Provisional Application Ser. No. 63/788,550, filed Apr. 14, 2025, which is hereby incorporated by reference in its entirety for any and all purposes.

### BACKGROUND

Scar tissue in organs, such as a heart, may affect organ function. A heart may develop scar tissue from a myocardial infarction or other cardiac events. Identification and mapping of scar tissue may be useful for planning and performing procedures, such as ablation therapy. Existing methods of identifying and mapping scar tissue lack a precision required for detailed mapping and tracking of scar tissue.

Improvements are needed.

### SUMMARY

It is to be understood that both the following general description and the following detailed description are exemplary and explanatory only and are not restrictive. Methods and systems for recognizing scar tissue in images are described.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Methods may include receiving an image of an anatomical structure. Methods may include determining, based on the image, a classification of tissue of the anatomical structure. The classification may include determining one or more of healthy tissue or scar tissue. Methods may include generating a first classification tag indicative of the determined healthy tissue. Methods may include generating a second classification tag indicative of the determined scar tissue. Methods may include causing the first classification tag and the second classification tag to be displayed. Other embodiments of this aspect include corresponding computer systems, apparatus, and computer programs recorded on one or more computer storage devices, each configured to perform the actions of the methods.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows example images described herein.

FIG. 2 shows example images described herein.

FIG. 3 shows example images described herein.

FIG. 4 shows example images described herein.

FIG. 5 shows an example graph described herein.

FIG. 6 shows a flowchart of an example method disclosed herein.

The accompanying drawings show examples of the disclosure. It is to be understood that the examples shown in the drawings and/or discussed herein are non-exclusive and that there are other examples of how the disclosure may be practiced.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

The present disclosure relates to using images, such as ultrasound images obtained from an imaging catheter to identify scar tissue. The images may comprise a detailed and dynamic view of a structure, such as an organ (heart, etc.) and associated movement of the structure (e.g., heart pumps, etc.). The present disclosure relates to using new algorithms and/or image processing techniques to identify scar tissue, including speckle tracking, texture analysis, machine learning (ML) algorithms trained to identify specific characteristics of scar tissue, etc. Once scar tissue is identified within the images, the scar tissue may be tagged with a visual marker, such as a color. The scar may be tracked in real time during a procedure based on anticipated movement of tissue during the procedure. As an example, normal behavior may be defined based on an expected healthy velocity and movement of tissue. By comparison to the normal (comparative) state, specific scar tissue and behavior of such tissue may be determined and used as training data for a model.

The present disclosure relates to using tagged scar tissue regions as a guide during a treatment, such as ablation therapy. The present disclosure may facilitate ensuring the treatment is targeted and effective. After treatment, the systems and methods described herein may be used to assess an extent of scar tissue removal and/or modification. The systems and methods described herein may be used to evaluate a success of the treatment.

As used herein, echogenicity may refer to an ability of tissue to reflect wave. The echogenicity of tissue may determine brightness of the tissue in ultrasound images.

As used herein, segmentation may refer to dividing an image into regions based on echogenicity to differentiate scar tissue from healthy tissue.

An example method of the present disclosure may comprise loading an image, enhancing the image, performing texture analysis on the image (or a derivative of the image), performing echogenicity-based segmentation on the image (or a derivative of the image), and performing classification on the image (or a derivative of the image). Loading the image may comprise receiving an image from an ultrasound catheter. Enhancing the image may comprise improving contrast in the image. Improving contrast in the image may facilitate better tissue distinction.

Performing texture analysis may comprise using local binary patterns (LBP) to analyze a texture of tissue illustrated in the image (or a derivative of the image, such as a version of the image with improved contrast). Analyzing the texture of the tissue may facilitate differentiating scar tissue from healthy tissue. Performing echogenicity-based segmentation on the image (or a derivative of the image) may comprise segmenting the image based on brightness using Otsu's thresholding to isolate regions of varying echogenicity.

Performing classification on the image (or a derivative of the image) may comprise classifying regions within the image as scar tissue or healthy tissue. Scar tissue may be determined by detecting inhomogeneous, irregular, and/or darker regions within the image. Healthy tissue may be determined by detecting brighter and more uniform regions within the image. An indication of scar tissue may be applied to regions determined to be scar tissue. For example, a first color may be applied to scar tissue. The first color may be green. An indication of healthy tissue may be applied to regions determined to be healthy tissue. For example, a second color may be applied to healthy tissue. The second color may be red.

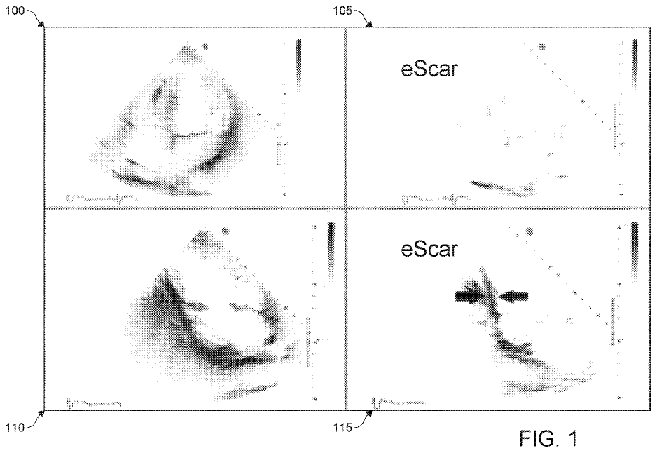

FIG. 1 shows example images 100, 110, 120, 130 described herein. As used herein, the term image may refer to data indicative of a human-viewable image. Such data and resultant images may be or comprise bi-plane or tri-plane data/images. Other data or images may be used. The images 100, 110, 120, 130 may comprise ultrasound images. The images 100, 110, 120, 130 may comprise bi-plane images received from an ultrasound catheter. The images 100, 110, 120, 130 may capture an anatomical structure. The anatomical structure may comprise tissue. The tissue may comprise healthy tissue. The tissue may comprise scar tissue. The anatomical structure may comprise an organ. The anatomical structure may comprise a heart. The images 100, 110, 120, 130, when taken with other images creating a video, may show movement of the anatomical structure.

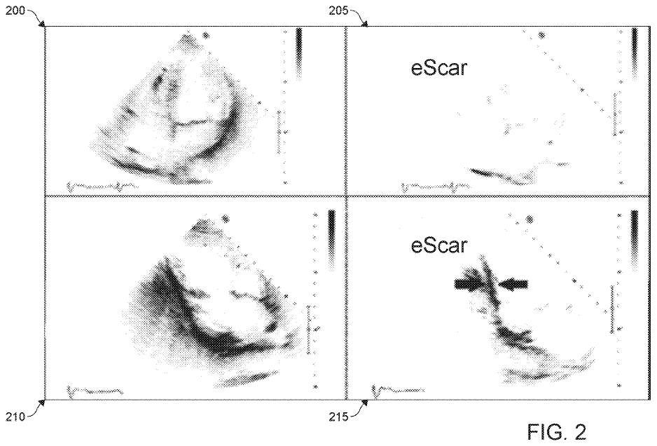

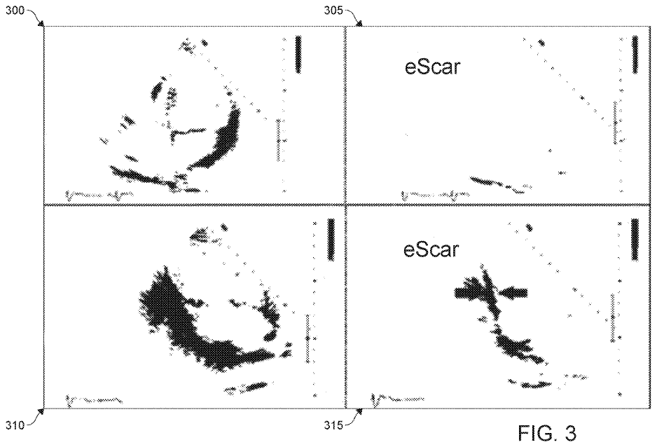

FIG. 2 shows example images 200, 210, 220, 230 described herein. The example images 200, 210, 220, 230 may comprise enhanced versions of the images 100, 110, 120, 130 in FIG. 1, respectively. As an example, enhancements may include an enhanced contrast for scar tissue determination. As a further example, echogenicity may be used to determine scar tissue based on sound waves/ultrasound waves and reflection characteristics from various tissue. As an illustration, FIG. 3 shows example images 300, 310, 320, 330 described herein. The example images 300, 310, 320, 330 may comprise echogenicity-based segmentation applied to the images 100, 110, 120, 130 in FIG. 1, respectively or the images 200, 210, 220, 230 in FIG. 2, respectively.

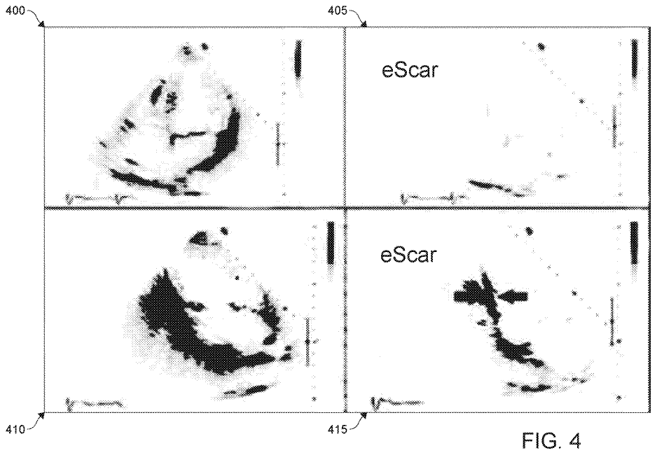

FIG. 4 shows example images 400, 410, 420, 430 described herein. The example images 400, 410, 420, 430 may comprise classification tags applied to the images 100, 110, 120, 130 in FIG. 1, respectively, the images 200, 210, 220, 230 in FIG. 2, respectively, or the images 300, 310, 320, 330 in FIG. 3, respectively. The classification tags may identify a classification of tissue. The classification tags may comprise colors. A red color may indicate healthy tissue. Healthy tissue may be determined based on uniform structure and/or echogenicity above a threshold. A green color may indicate scar tissue. Scar tissue may be determined based on irregular shapes and/or echogenicity below the threshold. Identifying scar tissue may facilitate understanding disease progression (e.g., after myocardial infarction) or evaluating tissue damage (e.g., fibrosis). The systems and methods described herein help doctors differentiate between healthy and abnormal tissue for better treatment planning.

The systems and methods described herein may be used with bi-plane imaging or tri-plane imaging. Other imaging and data indicative of imaging may be used. The systems and methods described herein offer enhanced visualization of scar tissue. The systems and methods described herein offer multiple views of scar tissue. Scar tissue may have irregular shapes and may be hard to fully appreciate in a single imaging plane. With bi-plane imaging, clinicians can simultaneously view the scar tissue from two different angles (e.g., longitudinal and transverse), offering a more complete assessment of its size, shape, and extent.

The systems and methods described herein may improve accuracy in measuring scar tissue. The systems and methods described herein may offer more precise sizing of scar tissue. Measuring dimensions of scar tissue can be challenging with a single view due to the irregularity of the tissue. By providing two orthogonal views, bi-plane imaging may allow for more accurate measurements in both length and width, which may assist in understanding the extent of fibrosis or tissue damage.

The systems and methods described herein may detect hidden and/or complex scar tissue. The systems and methods described herein may detect subtle and/or diffuse scar tissue. Scar tissue may not always be clearly visible in a single plane, especially if the scar tissue blends with surrounding tissues or is diffuse (spread over a large area). By providing two views, bi-plane imaging may help detect subtle or complex scar formations that might be missed in a single-plane scan.

The systems and methods described herein may provide a better understanding of scar progression. The systems and methods described herein may be used to track scar tissue over time. Scar tissue may evolve over time, becoming denser or more extensive. Bi-plane imaging may allow clinicians to track changes in scar tissue more effectively, as the clinicians may compare both planes across different time points.

The systems and methods described herein may help in characterization of scar complexity. Scar tissue may have varying levels of homogeneity or inhomogeneity. Bi-plane imaging may allow for better characterization of texture and/or echogenicity of scar tissue. Bi-plane imaging may help differentiate between denser, homogeneous scar tissue and more complex, inhomogeneous scar tissue.

The systems and methods described herein may improve spatial understanding. Viewing scar tissue in two planes (or more) may provide a better understanding of tissue location, tissue shape, and tissue interaction with surrounding tissue.

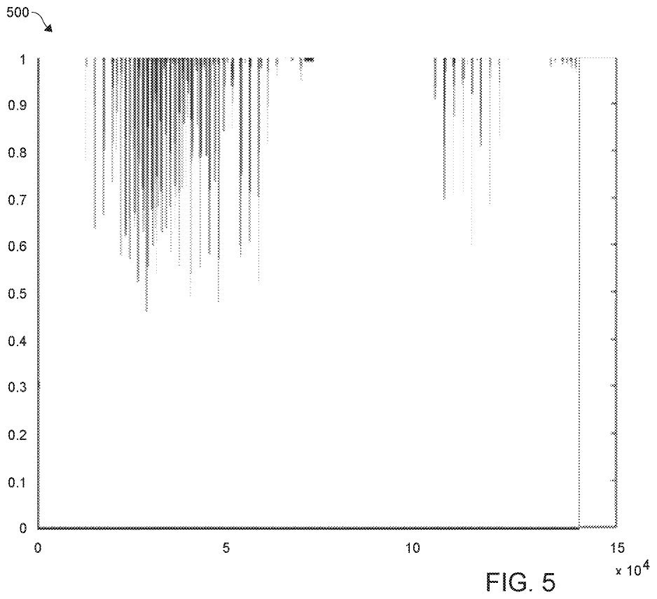

FIG. 5 shows an example graph 500 described herein. The graph 500 shows local binary patterns (LBP) texture features as a histogram. Local Binary Patterns (LBP) may be leveraged to analyze the texture of tissue (e.g., on a pixel basis), aiding in differentiating scar from healthy tissue. Determining the classification of the tissue of the anatomical structure may further comprise applying texture analysis to the enhanced image resulting in local binary pattern values associated with an enhanced image, as described herein. Determining the classification of the tissue of the anatomical structure may further comprise segmenting the enhanced image based on intensity resulting in a segmented image. The segmenting the enhanced image may comprise determining a gray threshold in the enhanced image and creating a binary image based on the gray threshold. Each pixel satisfying the gray threshold may comprise a first color. Each pixel failing to satisfy the gray threshold may comprise a second color. The first color may be white and the second color may be gray. The first color may be red and the second color may be green

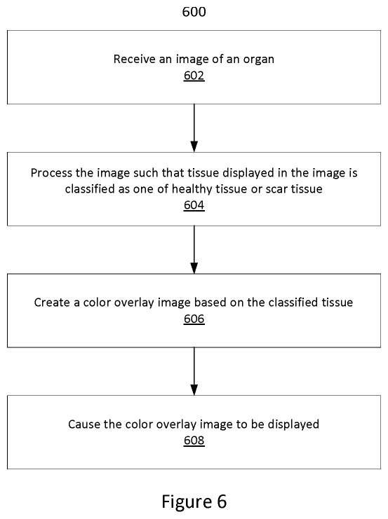

FIG. 6 shows a flowchart of an example method disclosed herein. FIG. 6 is a flowchart of an example process 600. In some implementations, one or more process blocks of FIG. 6 may be performed by a computing device, such as a processor or a control computer. Data indicative of an image or an image of an anatomical structure may be received (block 602). For example, one or more processors may receive an image of an anatomical structure.

A classification of tissue of the anatomical structure may be determined (block 604). For example, the one or more processors may determine a classification of tissue of the anatomical structure. The determining the classification of tissue of the anatomical structure may be based on the image. The classification may comprise determining one or more of healthy tissue or scar tissue. The determining the classification of the tissue of the anatomical structure may further comprise enhancing contrast in the image resulting in an enhanced image.

The enhanced image may be caused to be displayed. For example, the one or more processors may cause the enhanced image to be displayed. The enhancing contrast in the image may comprise converting the image into a grayscale image and enhancing the grayscale image to create the enhanced image. The determining the classification of the tissue of the anatomical structure may further comprise applying texture analysis to the enhanced image resulting in local binary pattern values associated with the enhanced image. The determining the classification of the tissue of the anatomical structure may further comprise segmenting the enhanced image based on intensity resulting in a segmented image. The segmenting the enhanced image may comprise determining a gray threshold in the enhanced image and creating a binary image based on the gray threshold. Each pixel satisfying the gray threshold may comprise a first color. Each pixel failing to satisfy the gray threshold may comprise a second color. The first color may be white and the second color may be gray. The first color may be red and the second color may be green.

The determining the classification of the tissue of the anatomical structure may further comprise applying region properties to the segmented image and/or the enhanced image to create a plurality of classified regions. Each region of the classified region may be classified as one of healthy tissue or scar tissue. The determining the classification of the tissue of the anatomical structure may be based on the plurality of classified regions.

A first classification tag indicative of the determined healthy tissue may be generated (block 606). For example, the one or more processors may generate a first classification tag indicative of the determined healthy tissue.

A second classification tag indicative of the determined scar tissue may be generated (block 608). For example, the one or more processors may generate a second classification tag indicative of the determined scar tissue.

One or more of the generating the first classification tag indicative of the determined healthy tissue and the generating the second classification tag indicative of the determined scar tissue may further comprise determining mean intensity values associated with the region properties, creating a mean intensity threshold based on the mean intensity values, determining eccentricity values associated with the region properties, and creating an eccentricity threshold based on the eccentricity values.

For each region, a determination may be made of if a mean intensity value associated with the region does not satisfy the mean intensity threshold or if an eccentricity associated with the region satisfies the eccentricity threshold. For example, the one or more processors may make a determination, for each region, of if a mean intensity value associated with the region does not satisfy the mean intensity threshold or if an eccentricity associated with the region satisfies the eccentricity threshold.

For each region, if the mean intensity value associated with the region is determined to not satisfy the mean intensity threshold or if the eccentricity associated with the region is determined to satisfy the eccentricity threshold, the region may be associated with a first color. For example, the one or more processors may, for each region, if the mean intensity value associated with the region is determined to not satisfy the mean intensity threshold or if the eccentricity associated with the region is determined to satisfy the eccentricity threshold, associate the region with a first color. The first color may be associated with scar tissue. The first color may be green.

For each region, if the mean intensity value associated with the region is determined to satisfy the mean intensity threshold and the eccentricity associated with the region is determined to not satisfy the eccentricity threshold, the region may be associated with a second color. For example, the one or more processors may, for each region, if the mean intensity value associated with the region is determined to satisfy the mean intensity threshold and the eccentricity associated with the region is determined to not satisfy the eccentricity threshold, associate the region with a second color. The second color is associated with healthy tissue. The second color may be red.

The first classification tag and the second classification tag may be caused to be displayed (block 610). For example, the one or more processors may cause the first classification tag and the second classification tag may be caused to be displayed.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

An example implementation of process 600 may comprise determining (e.g., selecting) an ultrasound image file. Selecting an ultrasound image file may comprise presenting possible image files to a user for selection.

The example implementation of process 600 may comprise loading and displaying the selected ultrasound image. Loading and displaying the selected ultrasound image may comprise converting the selected ultrasound image into a grayscale image. A size of the grayscale image may be determined. Various sizes and resolutions may be used.

The example implementation of process 600 may comprise enhancing contrast to the grayscale image to create an enhanced image. The enhanced image may better visualize echogenicity differences. Enhancing contrasts may be effected using various processes, as described herein.

The example implementation of process 600 may comprise applying texture analysis to the enhanced image to create local binary patterns (LBP) data associated with the enhanced image.

The example implementation of process 600 may comprise segmenting the image based on intensity.

The example implementation of process 600 may comprise applying region properties to classify regions of the enhanced image. The regions of the enhanced image may be classified as scar tissue or healthy tissue.

The example implementation of process 600 may comprise defining dynamic thresholds based on image statistics. Image statistics may comprise mean intensity values, eccentricity values, etc.

The example implementation of process 600 may comprise creating a color overlay over the grayscale image. The color overlay may comprise a first color for scar tissue and a second color for healthy tissue.

The example implementation of process 600 may comprise looping through each detected region and marking pixels associated with tissue. Pixels may be marked as healthy tissue or scar tissue.

The example implementation of process 600 may comprise showing images at various steps. For example, the grayscale image may be shown. The enhanced image may be shown. A plot of the LBP data may be shown. An image with echogenicity-based segmentation may be shown. The grayscale with the color overlay may be shown.

An example implementation of process 600 may be shown in the MATLAB code reproduced here:
% MATLAB Code: Ultrasound Image Processing for Scar Tissue Detection Based on Echogenicity
% Step 1: Open a dialog to select the ultrasound image file
[filename, pathname]=uigetfile({‘*.jpg; *.png; *.jpeg’, ‘Image Files (*.jpg, *.png, *.jpeg)’}, ‘Select an Ultrasound Image’);
if isequal(filename,0)
   disp('User canceled file selection');
   return;
end
% Construct the full file path
ultrasoundImageFile=fullfile(pathname, filename);
% Step 2: Load and display the selected ultrasound image
I=imread(ultrasoundImageFile);
% Convert to grayscale if it's not already
if size(I, 3)==3
   I=rgb2gray(I);
end
% Get the size of the image
[imageHeight, imageWidth]=size(I);
% Step 3: Enhance the contrast to better visualize the echogenicity differences
I_enhanced=imadjust(I);
% Step 4: Apply texture analysis using Local Binary Patterns (LBP)
lbpImage=extractLBPFeatures(I_enhanced, ‘CellSize’, [32 32]);
% Step 5: Segment the image based on intensity (brightness)
threshold=graythresh(I_enhanced);
echogenicMask=imbinarize(I_enhanced, threshold);
% Step 6: Apply region properties to classify regions as scar tissue (green) or healthy tissue (red)
regionProps=regionprops(echogenicMask, I_enhanced, ‘Area’, ‘Eccentricity’, ‘MeanIntensity’, ‘PixelIdxList’);
% Step 7: Define dynamic thresholds based on image statistics
meanIntensityValues=[regionProps. MeanIntensity];
meanIntensityThreshold=mean(meanIntensityValues)−0.2*std(meanIntensityValues); % Adjust dynamically
eccentricityValues=[regionProps.Eccentricity];
eccentricityThreshold=mean(eccentricityValues)+0.2*std(eccentricityValues); % Adjust dynamically
minArea=50; % Minimum area to filter out small regions
% Step 8: Create a color overlay for marking scar tissue (green) and healthy tissue (red)
colorOverlay=cat(3, I, I, I); % Convert grayscale image to RGB
% Define colors for different types of regions
scarColor=[0, 255, 0]; % Green for scar tissue
healthyColor=[255, 0, 0]; % Red for healthy tissue
% Step 9: Loop through each detected region and mark scar or healthy tissue
for k=1: length(regionProps)
   % Get the pixel indices of the region
   pixelIdx=regionProps(k).PixelIdxList;
% Apply area filtering to remove small regions
   if regionProps(k).Area>minArea
      % Mark as scar tissue (green) if it's inhomogeneous/irregular
      if regionProps(k).MeanIntensity<meanIntensityThreshold||regionProps(k).Eccentricity>eccentricityThreshold
         % Mark as scar tissue (green)
         colorOverlay(pixelIdx)=scarColor(1); % Red channel
         colorOverlay(pixelIdx+numel(I))=scarColor(2); % Green channel colorOverlay(pixelIdx+2*numel(I))=scarColor(3); % Blue channel
      else
         % Mark as healthy tissue (red)
         colorOverlay(pixelIdx)=healthyColor(1); % Red channel
         colorOverlay(pixelIdx+numel(I))=healthyColor(2); % Green channel (set to 0 for red)
         colorOverlay(pixelIdx+2*numel(I))=healthyColor(3); % Blue channel (set to 0 for red)
      end
   end
end
% Create a figure to show all the steps in a single plot
figure;
sgtitle(‘Ultrasound Image Processing for Scar Tissue Based on Echogenicity’)
% Subplot 1: Display the original image
subplot(2, 3, 1);
imshow(I);
title(‘Original Ultrasound Image’);
% Subplot 2: Display the enhanced image with better contrast
subplot(2, 3, 2);
imshow(I_enhanced);
title(‘Enhanced Contrast Image’);
% Subplot 3: Display the LBP feature vector as a plot
subplot(2, 3, 3);
plot(lbpImage);
title(‘LBP Texture Features’);
% Subplot 4: Display the segmentation result (based on echogenicity)
subplot(2, 3, 4);
imshow(echogenicMask);
title(‘Echogenicity-Based Segmentation’);
% Subplot 5: Display the original image with detected regions marked by scar or healthy tissue
subplot(2, 3, 5);
imshow(colorOverlay);
title(‘Scar Tissue Detection with Color Marking’);

Although specific code is shown hereinabove, it is understood that other specific implementations of the same or similar steps may be implemented without departing from the spirit of the methods disclosed herein.

The systems and methods described herein may utilize, for example, the biplane mode of a 4D ICE catheter, which allows simultaneous visualization of the heart from two orthogonal planes. This dual perspective may be used to provide a more comprehensive view of the scar tissue, enabling precise localization and assessment of its extent and morphology.

As a further illustration, the present methods integrate modelling such as artificial intelligence models, specifically designed to work with biplane/tri-plane imaging data (although not limiting to such data). AI tools may employ advanced algorithms, including deep learning models, which are trained on a diverse dataset of biplane cardiac images. These models are adept at recognizing the unique textural and structural characteristics of scar tissue across different planes and angles. Other data and models may be used.

As a further example, methods of present disclosure may comprise data collection and preprocessing. For example, a dataset indicative of cardiac images may be collected, typically from ultrasound, MRI, or CT scans, which may include labeled examples of scar tissue. These images are preprocessed to enhance quality, normalize intensity, remove noise, and sometimes segment the heart from the surrounding tissues to focus the analysis.

Where the algorithm identifies and isolates characteristics of the images that are relevant for distinguishing scar tissue from healthy tissue. Features might include, for example, texture features: analyzing the texture of the tissue, as scar tissue often appears rougher or more irregular compared to normal myocardium; geometric features: identifying shapes and contours that are typical of scar formations; intensity and gradient features: scar tissues may have different intensity profiles due to their denser or fibrous nature; temporal features: in the case of dynamic (4D) imaging, changes over time can also be important indicators. Other features may be determined.

Without limitation, various types of algorithms/models may be used. Supervised Learning Algorithms may be used such as support vector machines (SVM), random forests, or deep neural networks (DNNs) are common. These models learn to associate the extracted features with the presence or absence of scar tissue based on training data that has been annotated by experts. Deep Learning Models, particularly Convolutional Neural Networks (CNNs), are highly effective in image analysis. These models can automatically detect intricate patterns in the images without needing manually extracted features, learning directly from the raw pixels.

The trained model may be validated and tested on separate sets of images not used during training. This step is crucial to ensure the model's accuracy, generalizability, and reliability in real clinical settings.

Once validated, the machine learning model may be deployed within clinical imaging systems. When new cardiac images are taken, the model can analyze them in real time to identify and highlight scar tissues, assisting clinicians in diagnosis and treatment planning.

Machine learning models can continue to improve over time with feedback from clinical use. As more data becomes available and more scar tissue examples are annotated, the model can be retrained or fine-tuned to enhance its accuracy and adapt to new types of data or imaging technologies.

As a further illustrative example, once the scar tissue is identified (e.g., via AI model) the scar tissue is automatically marked within the imaging interface. Such tagging may be automatic and dynamic, adjusting in real time to changes in the heart's position and morphology during the cardiac cycle. This ensures that the marked areas remain accurate and relevant throughout the procedure, despite the heart's movements.

By employing these sophisticated algorithms, the field of cardiology can advance significantly in the precision treatment of conditions like arrhythmias, where the accurate mapping of scar tissue is essential.

### EXAMPLE CLAUSES

Example Clause 1: A method may include: receiving data indicative of an image of an anatomical structure; determining, based on the data/image, a classification of tissue of the anatomical structure, where the classification may include determining one or more of healthy tissue or scar tissue; generating a first classification tag indicative of the determined healthy tissue; generating a second classification tag indicative of the determined scar tissue; and causing the first classification tag and the second classification tag to be displayed.

Example Clause 2: The method of Example Clause 1, where the determining the classification of the tissue of the anatomical structure further may include enhancing contrast in the image resulting in an enhanced image.

Example Clause 3: The method of Example Clause 1 or Example Clause 2, further may include causing the enhanced image to be displayed.

Example Clause 4: The method of any one of Example Clauses 1-3, where the enhancing contrast in the image may include converting the image into a grayscale image and enhancing the grayscale image to create the enhanced image.

Example Clause 5: The method of any one of Example Clauses 1-4, where the determining the classification of the tissue of the anatomical structure further may include applying texture analysis to the enhanced image resulting in local binary pattern values associated with the enhanced image.

Example Clause 6: The method of any one of Example Clauses 1-5, where the determining the classification of the tissue of the anatomical structure further may include segmenting the enhanced image based on intensity resulting in a segmented image.

Example Clause 7: The method of any one of Example Clauses 1-6, where the determining the classification of the tissue of the anatomical structure further may include applying region properties to the segmented image and/or the enhanced image to create a plurality of classified regions, where each region of the classified region is classified as one of healthy tissue or scar tissue.

Example Clause 8: The method of any one of Example Clauses 1-7, where the determining the classification of the tissue of the anatomical structure is based on the plurality of classified regions.

Example Clause 9: The method of any one of Example Clauses 1-8, where one or more of the generating the first classification tag indicative of the determined healthy tissue and the generating the second classification tag indicative of the determined scar tissue further may include determining mean intensity values associated with the region properties, creating a mean intensity threshold based on the mean intensity values, determining eccentricity values associated with the region properties, and creating an eccentricity threshold based on the eccentricity values.

Example Clause 10: The method of any one of Example Clauses 1-9, further may include, for each region: determining if a mean intensity value associated with the region does not satisfy the mean intensity threshold or if an eccentricity associated with the region satisfies the eccentricity threshold; if the mean intensity value associated with the region is determined to not satisfy the mean intensity threshold or if the eccentricity associated with the region is determined to satisfy the eccentricity threshold, associating the region with a first color, where the first color is associated with scar tissue; and if the mean intensity value associated with the region is determined to satisfy the mean intensity threshold and the eccentricity associated with the region is determined to not satisfy the eccentricity threshold, associating the region with a second color, where the second color is associated with healthy tissue.

Example Clause 11: The method of any one of Example Clauses 1-10, where the first color is green and the second color is red.

Example Clause 12: The method of any one of Example Clauses 1-11, where the segmenting the enhanced image may include determining a gray threshold in the enhanced image and creating a binary image based on the gray threshold, where each pixel satisfying the gray threshold may include a first color, and where each pixel failing to satisfy the gray threshold may include a second color.

Example Clause 13: The method of any one of Example Clauses 1-12, where the first color is white and the second color is gray.

Example Clause 14: The method of any one of Example Clauses 1-13, where the first color is red and the second color is green.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving first data indicative of an image of an anatomical structure;
determining, based on the first data, a classification of tissue of the anatomical structure, wherein the classification comprises determining one or more of healthy tissue or scar tissue;
generating a first classification tag indicative of the determined healthy tissue;
generating a second classification tag indicative of the determined scar tissue; and
causing the first classification tag and the second classification tag to be displayed.

2. The method of claim 1, wherein the first data is indicative of one or more of bi-plane or tri-plane images.

3. The method of claim 1, wherein the first data is indicative of one or more of 2D, 3D, or 4D ultrasound images.

4. The method of claim 1, wherein the determining the classification of the tissue of the anatomical structure further comprises enhancing contrast in the image resulting in an enhanced image.

5. The method of claim 4, further comprising causing the enhanced image to be displayed.

6. The method of claim 4, wherein the enhancing contrast in the image comprises converting the image into a grayscale image and enhancing the grayscale image to create the enhanced image.

7. The method of claim 4, wherein the determining the classification of the tissue of the anatomical structure further comprises applying texture analysis to the enhanced image resulting in local binary pattern values associated with the enhanced image.

8. The method of claim 7, wherein the determining the classification of the tissue of the anatomical structure further comprises segmenting the enhanced image based on intensity resulting in a segmented image.

9. The method of claim 8, wherein the determining the classification of the tissue of the anatomical structure further comprises applying region properties to the segmented image and/or the enhanced image to create a plurality of classified regions, wherein each region of the classified region is classified as one of healthy tissue or scar tissue.

10. The method of claim 9, wherein the determining the classification of the tissue of the anatomical structure is based on the plurality of classified regions.

11. The method of claim 8, wherein the segmenting the enhanced image comprises determining a gray threshold in the enhanced image and creating a binary image based on the gray threshold, wherein each pixel satisfying the gray threshold comprises a first color, and wherein each pixel failing to satisfy the gray threshold comprises a second color.

12. The method of claim 11, wherein the first color is white and the second color is gray.

13. The method of claim 11, wherein the first color is red and the second color is green.

14. The method of claim 9, wherein one or more of the generating the first classification tag indicative of the determined healthy tissue and the generating the second classification tag indicative of the determined scar tissue further comprise determining mean intensity values associated with the region properties, creating a mean intensity threshold based on the mean intensity values, determining eccentricity values associated with the region properties, and creating an eccentricity threshold based on the eccentricity values.

15. The method of claim 14, further comprising, for each region:
determining if a mean intensity value associated with the region does not satisfy the mean intensity threshold or if an eccentricity associated with the region satisfies the eccentricity threshold;
if the mean intensity value associated with the region is determined to not satisfy the mean intensity threshold or if the eccentricity associated with the region is determined to satisfy the eccentricity threshold, associating the region with a first color, wherein the first color is associated with scar tissue; and
if the mean intensity value associated with the region is determined to satisfy the mean intensity threshold and the eccentricity associated with the region is determined to not satisfy the eccentricity threshold, associating the region with a second color, wherein the second color is associated with healthy tissue.

16. The method of claim 15, wherein the first color is green and the second color is red.

17. A method comprising:
receiving first data indicative of an image of an anatomical structure;
determining, based on the first data, a classification of tissue of the anatomical structure, wherein the classification comprises determining one or more of healthy tissue or scar tissue, wherein the determining the classification of the tissue of the anatomical structure further comprises enhancing contrast in the image resulting in an enhanced image, and wherein the determining the classification of the tissue of the anatomical structure further comprises applying texture analysis to the enhanced image resulting in local binary pattern values associated with the enhanced image;
generating, based on at least the local binary pattern values associated with the enhanced image, a first classification tag indicative of the determined healthy tissue;
generating, based on at least the local binary pattern values associated with the enhanced image, a second classification tag indicative of the determined scar tissue; and
causing the first classification tag and the second classification tag to be displayed.

18. The method of claim 17, wherein the determining the classification of the tissue of the anatomical structure further comprises segmenting the enhanced image based on intensity resulting in a segmented image.

19. The method of claim 18, wherein the determining the classification of the tissue of the anatomical structure further comprises applying region properties to the segmented image and/or the enhanced image to create a plurality of classified regions, wherein each region of the classified region is classified as one of healthy tissue or scar tissue.

20. The method of claim 19, wherein the determining the classification of the tissue of the anatomical structure is based on the plurality of classified regions.

21. The method of claim 20, wherein the segmenting the enhanced image comprises determining a gray threshold in the enhanced image and creating a binary image based on the gray threshold, wherein each pixel satisfying the gray threshold comprises a first color, and wherein each pixel failing to satisfy the gray threshold comprises a second color.
